(19) United States
(12) Patent Application Publication
(10) Pub. No.: US 2023/0045295 A1
(43) Pub. Date: Feb. 9, 2023

(54) AIDC DEVICE CRADLE

(71) Applicant: Charles Cagliostro, Bronxville, NY (US)

(72) Inventor: Charles Cagliostro, Bronxville, NY (US)

(21) Appl. No.: 17/972,385

(22) Filed: Oct. 24, 2022

Related U.S. Application Data
(63) Continuation-in-part of application No. 17/674,115, filed on Feb. 17, 2022.
(60) Provisional application No. 63/220,372, filed on Jul. 9, 2021.

(51) Int. Cl. F16M 13/02; F16M 11/10; F16M 11/16; F16M 11/20

(52) U.S. Cl. CPC F16M 13/022; F16M 11/10; F16M 11/16; F16M 11/2021; F16M 2200/068; F16M 2200/02

(57) ABSTRACT

An AIDC device cradle includes a movable stand having a post, base plate, and an axle head. A cradle tray is rotatably attached to the axle head via a pivot pin. The cradle tray is configured to receive and accommodate an AIDC device case with an AIDC device. A plurality of locking holes and slots are provided to lock the AIDC device case in position and secure the AIDC device within the device cradle. Integrated charging options are provided. An opening or viewing port is provided on both the AIDC device case and cradle tray enabling the AIDC device scanner to be operational in a downward position.

### CROSS-REFERENCE TO RELATED APPLICATIONS

The present application is a continuation in part application to U.S. Non-Provisional patent application Ser. No. 17/674,115, filed Feb. 17, 2022 which claims priority to U.S. Provisional Patent Application serial number 63/220,372, filed on Jul. 9, 2021 entitled “AIDC Device Cradle”, the disclosures of which are hereby incorporated in its entirety at least by reference.

### BACKGROUND OF THE INVENTION

### 1. Field of the Invention

The present invention generally relates to AIDC devices, more specifically it relates to a locking adjustable cradle with onboard charger for AIDC devices.

### 2. Description of Related Art

AIDC (Automatic identification and data capture) is a term used to group together several different device technologies that are used to automatically identify items, collect data, and enter this data into computer systems. Most of the data that is captured by such devices is attached to barcodes, RFID-equipped access cards, or Smart Cards which can be enhanced further with the use of Biometric data. There have been advancements in AIDC over the years and it is now possible for users around the world to interact with millions of business processes and systems using AIDC devices. Object tracking using Electronic Article Surveillance (EAS) systems which also uses RFID Tags prevents theft of the items from stores. Locating objects through the uses of Real Time Locating Systems (RTLS) to name just a couple of the many opportunities which AIDC based technology has to offer. As such devices began to appear in most retail environments, merchants began looking at ways to make them more stable, secure and presentable to their operators. Consequently, a solution is needed.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present invention to provide an AIDC cradle that can receive an AIDC device that is configured to be adjusted to various angles to facilitate the operation and use while charging and preventing theft of the AIDC device. It is another object of the present invention to provide an AIDC cradle that is configured to securely mount to a flat surface.

In order to do so, an AIDC device cradle is provided, comprising-a stand having a top portion and a bottom portion, the bottom portion attached to a base plate and the top portion attached to an axle head; a cradle tray rotatably attached to the axle head via a pivot pin, wherein the cradle tray is configured to receive an AIDC device case, the AIDC device case is configured to hold an AIDC device having a scanner, wherein the cradle tray includes a plurality of openings enabling a user to lock the AIDC device case within the cradle tray; and, a bottom side of the cradle tray and an end portion of the AIDC case each having a view port opening enabling the scanner to be operational within the AIDC device cradle when the scanner is in a downward position.

In one embodiment, the cradle tray and the AIDC case each comprise an integrated charger connection configured to charge the AIDC device when the AIDC device is positioned in the AIDC device cradle. In one embodiment, the stand includes a movable arm having a first portion and a second portion, wherein the first portion is attached to the base plate and the top portion is attached to the axle head. In one embodiment, the base plate includes holes configured to receive fasteners such that the base plate may be fixed to a surface. In one embodiment, the AIDC device cradle is constructed from a rigid material. In another embodiment, the cradle tray is configured to receive the AIDC device case and AIDC device in either vertical orientation such the scanner is in an upward or downward position.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

It is briefly noted that upon reading this disclosure, those skilled in the art will recognize various means for carrying out these intended features of the invention. As such, it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of an AIDC device cradle according to an embodiment of the present invention.

FIG. 2 is a perspective view of the AIDC device cradle with the AIDC device inside the AIDC Case removed from the cradle according to an embodiment of the present invention.

FIG. 3 is a perspective detailed view of the AIDC Case partially inserted into the tray of the AIDC device cradle according to an embodiment of the present invention.

FIG. 4 is a perspective detailed view of the tray of the AIDC device cradle with the AIDC case inserted into the tray according to an embodiment of the present invention.

FIG. 5 is a perspective detailed view of the tray of the AIDC device with the AIDC device inside the AIDC case removed from the tray according to an embodiment of the present invention.

FIG. 6 is a perspective detailed view of the tray of the AIDC device cradle according to an embodiment of the present invention.

FIG. 7 is a perspective detailed view of the tray of the AIDC device cradle according to an embodiment of the present invention.

FIG. 8 is a perspective detailed view of the tray of the AIDC device cradle according to an embodiment of the present invention.

FIG. 9 is a perspective detailed view of the tray of the AIDC device cradle according to an embodiment of the present invention.

FIG. 10 is a side detailed view of the tray of the AIDC device cradle according to an embodiment of the present invention with a laptop security lock engaged in the tray

FIG. 11 is a front detailed view of the tray of the AIDC device cradle according to an embodiment of the present invention with a laptop security lock engaged in the security slot of the tray.

FIG. 12 is a side detailed view of the tray of the AIDC device cradle according to an embodiment of the present invention.

FIG. 13 is a top detailed view of the tray of the AIDC device cradle according to an embodiment of the present invention and a laptop security lock engaged in the security slot of the tray.

FIG. 14 is a bottom detailed view of the tray of the AIDC device cradle according to an embodiment of the present invention and a laptop security lock engaged in the security slot of the tray.

FIG. 15 is a rear perspective view of the AIDC device case with the AIDC device installed without the stand or tray shown according to an embodiment of the present invention.

FIG. 16 is a side view of the AIDC device case with the AIDC device installed without the stand or tray shown according to an embodiment of the present invention.

FIG. 17 is a rear view of the AIDC device case with the AIDC device installed without the stand or tray shown according to an embodiment of the present invention.

FIG. 18 is a front view of the AIDC device case with the AIDC device installed without the stand or tray shown according to an embodiment of the present invention.

FIG. 19 is a top view of the AIDC device case with the AIDC device installed without the stand or tray shown according to an embodiment of the present invention.

FIG. 20 is a perspective view of the AIDC device cradle without the AIDC device installed and detailed view showing the charging pins according to an embodiment of the present invention.

FIG. 21 is a perspective view of the electrical wiring and AIDC case end cap for the AIDC case which connects the AIDC device charging pads to pads on each end of the AIDC case according to an embodiment of the present invention.

FIG. 22 is a perspective view of the electrical wiring for the AIDC case with the AIDC device cradle hidden according to an embodiment of the present invention.

FIG. 23 is a perspective view of the end cap for the AIDC device case with USB access hole according to an embodiment of the present invention.

FIG. 24 is a top view of the end cap for the AIDC device case according to an embodiment of the present invention.

FIG. 25 is a front view of the end cap for the AIDC device case according to an embodiment of the present invention

FIG. 26 is a bottom view of the end cap for the AIDC device case according to an embodiment of the present invention

FIG. 27 is a back view of the end cap for the AIDC device case showing the USB access hole and channels for electrical wiring according to an embodiment of the present invention

FIG. 28 is a rear perspective view of the AIDC device cradle with the AIDC device removed from the cradle according to an embodiment of the present invention.

FIG. 29 is a perspective view of an AIDC device cradle according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide an AIDC device cradle.

It is to be understood that the terminology used herein is for the purpose of describing particular embodiments only and is not intended to be limiting. The terms “a” or “an,” as used herein, are defined as to mean “at least one”. The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about”, “generally”, or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

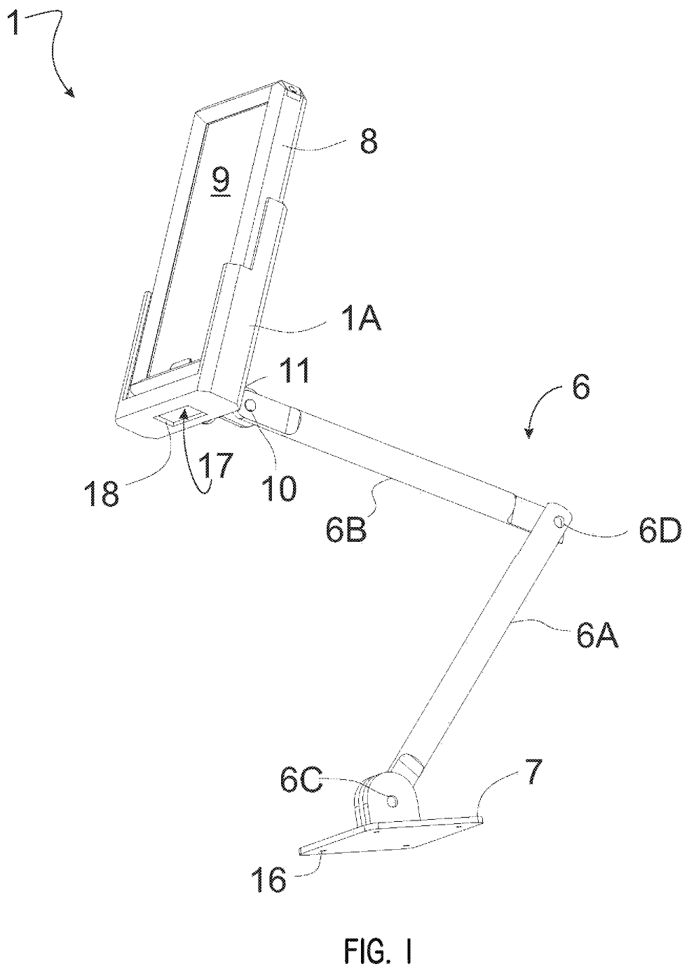

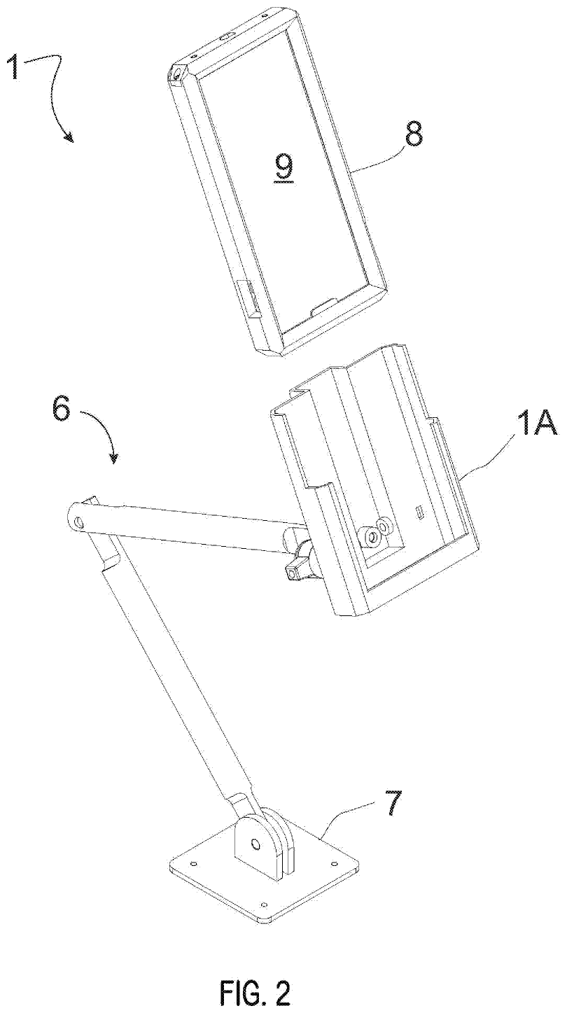

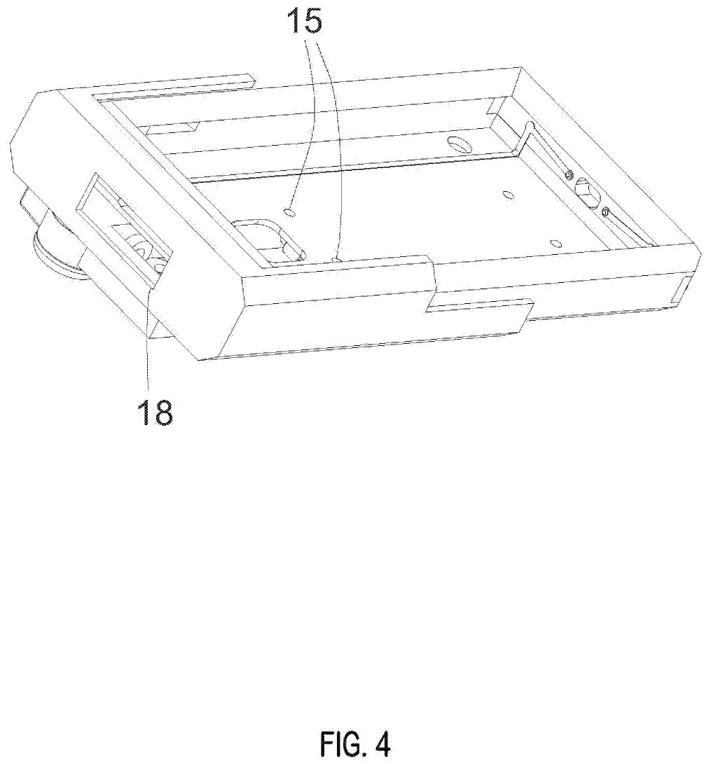

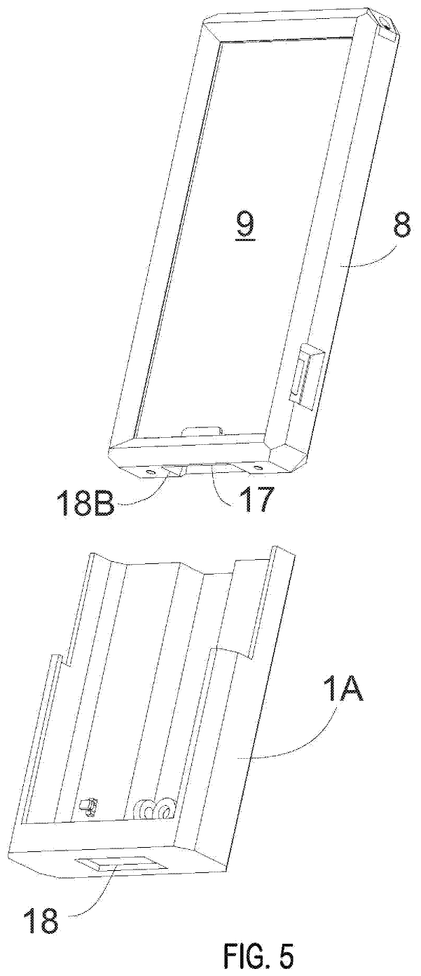

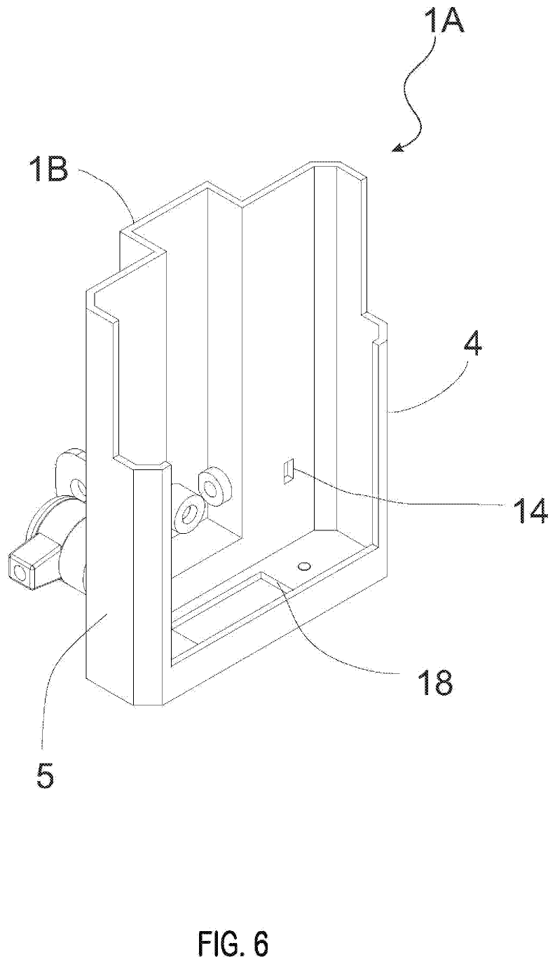

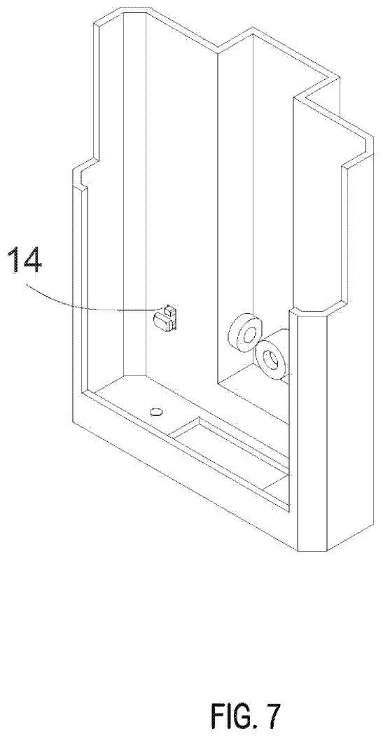

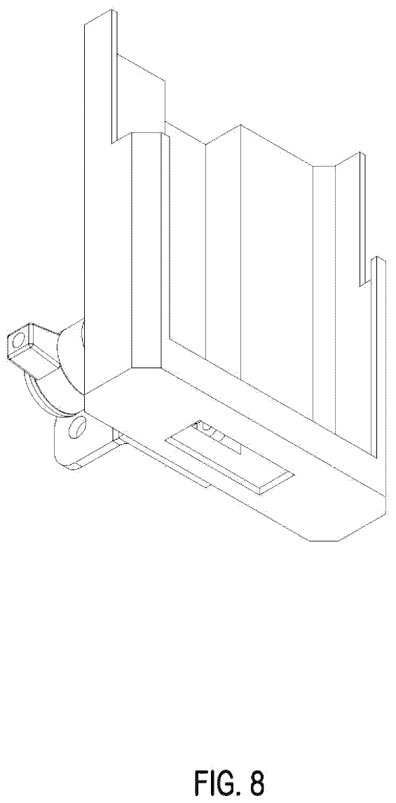

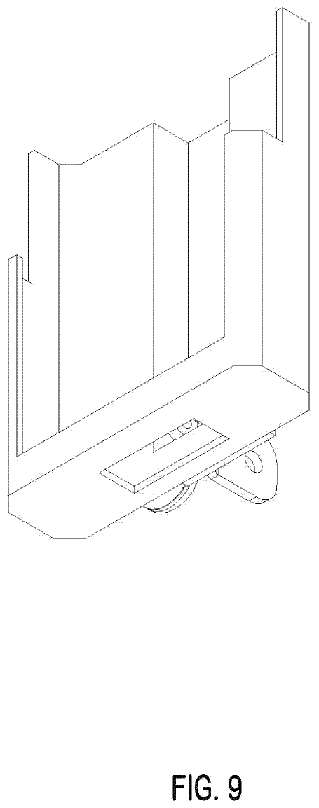

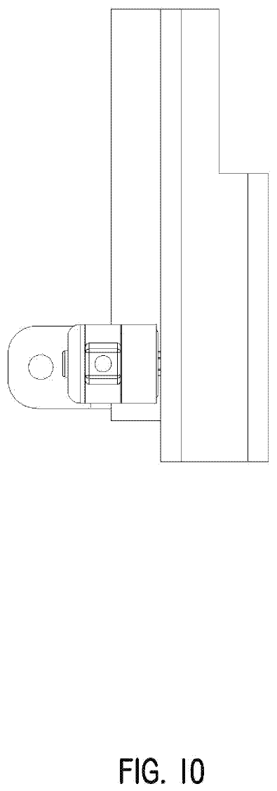

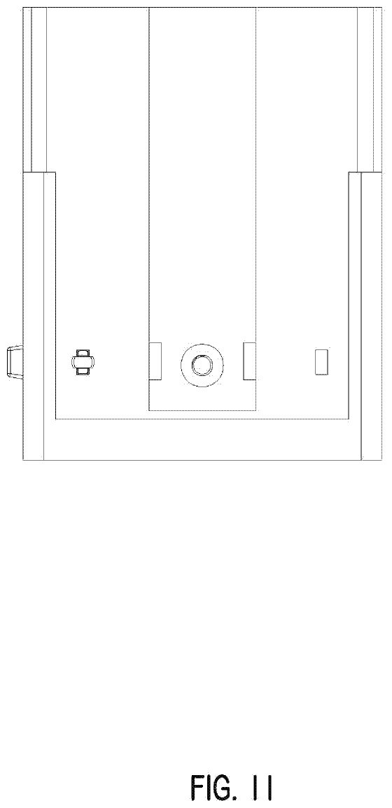

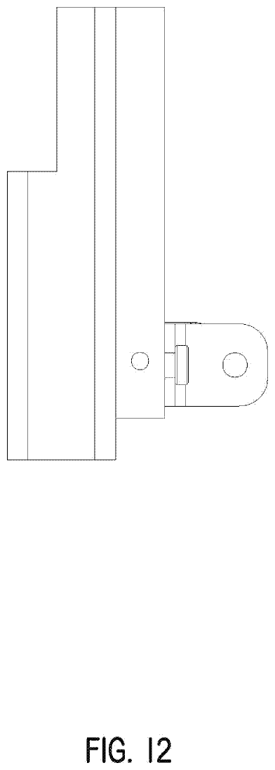

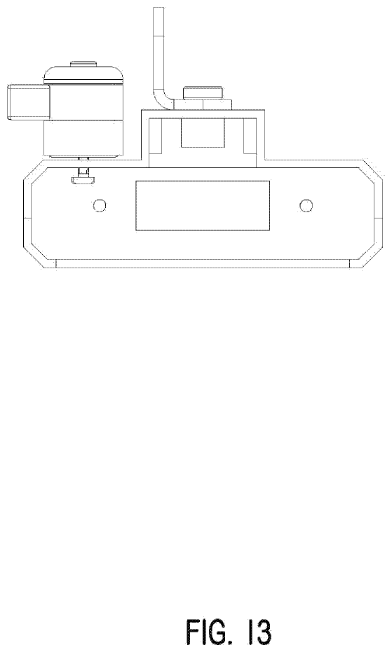

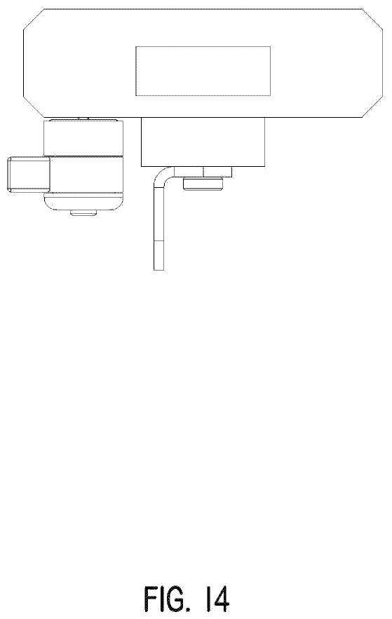

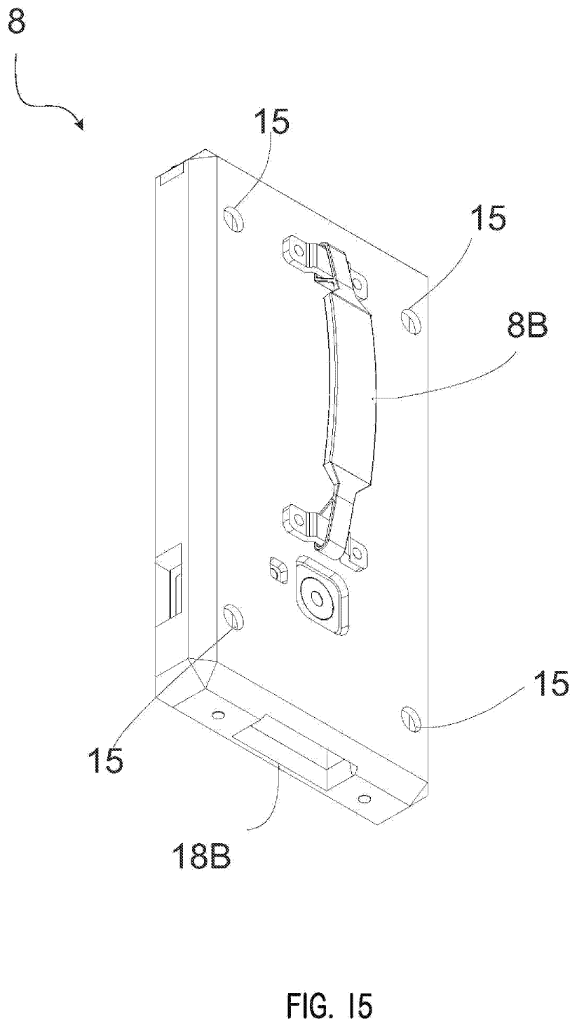

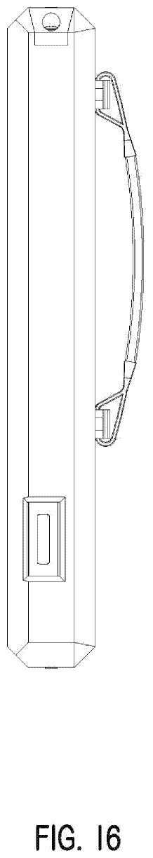

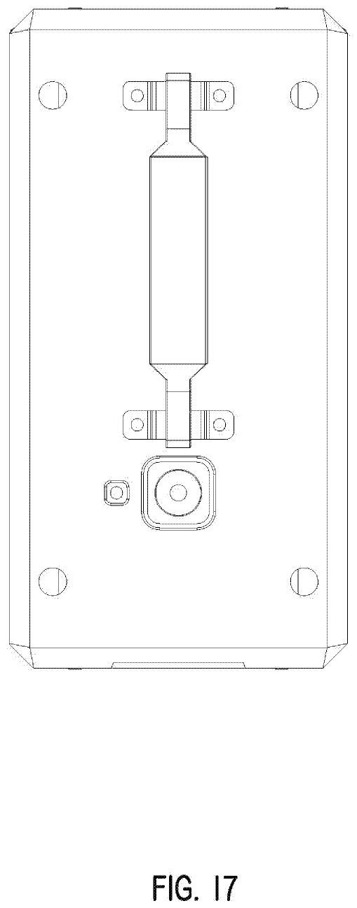

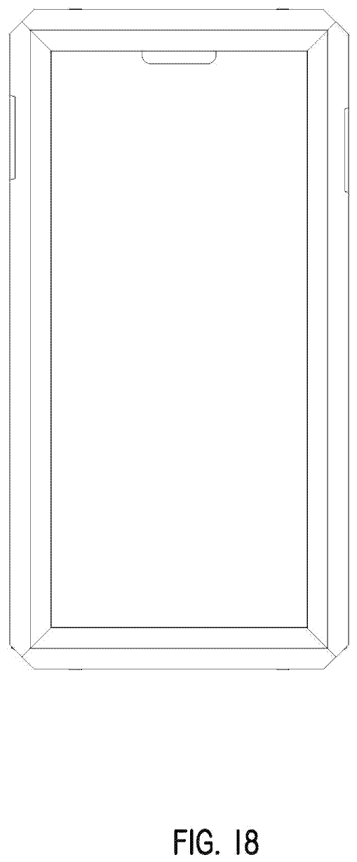

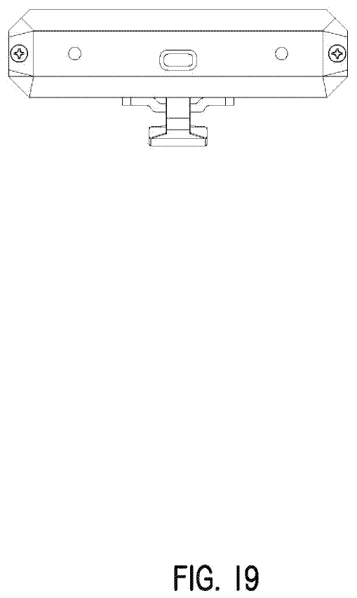

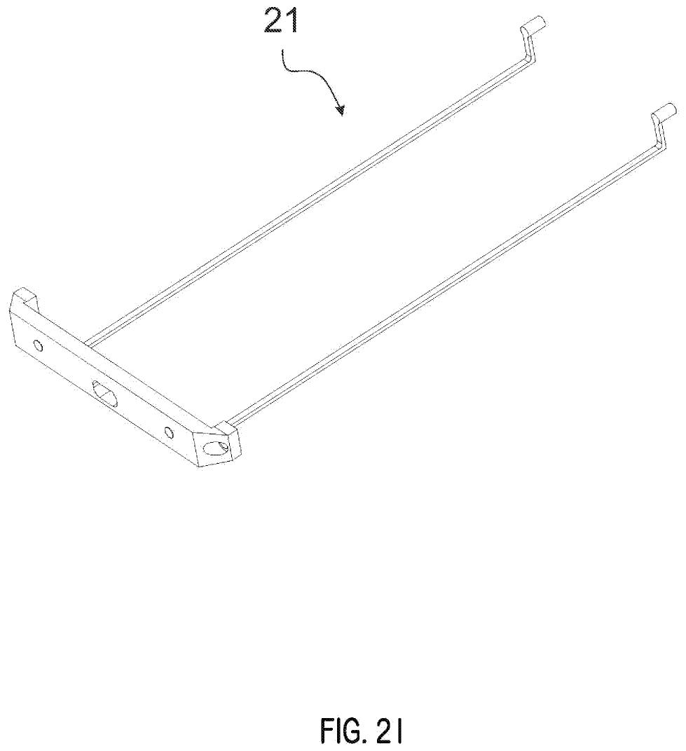

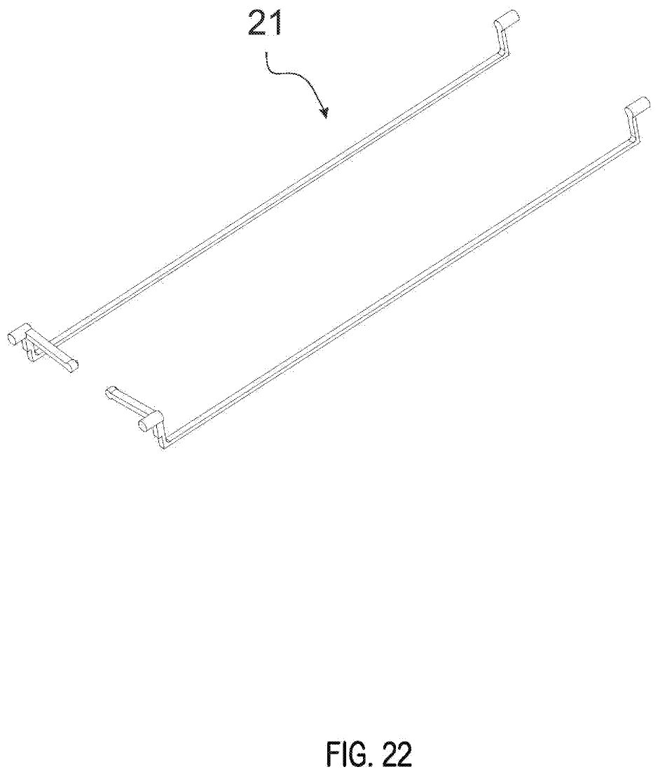

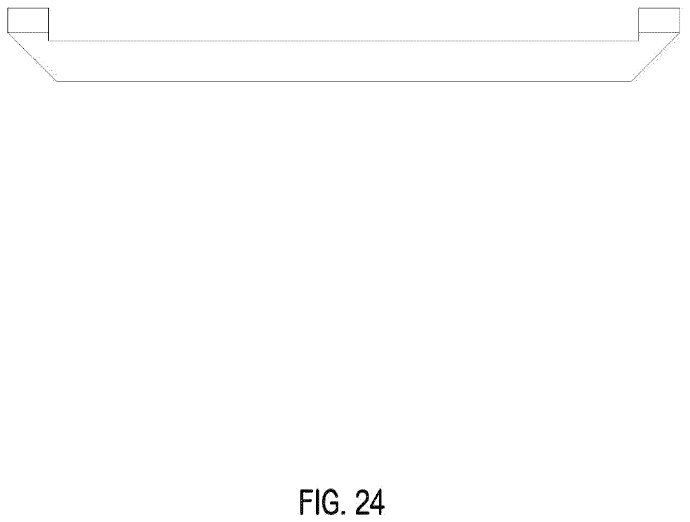

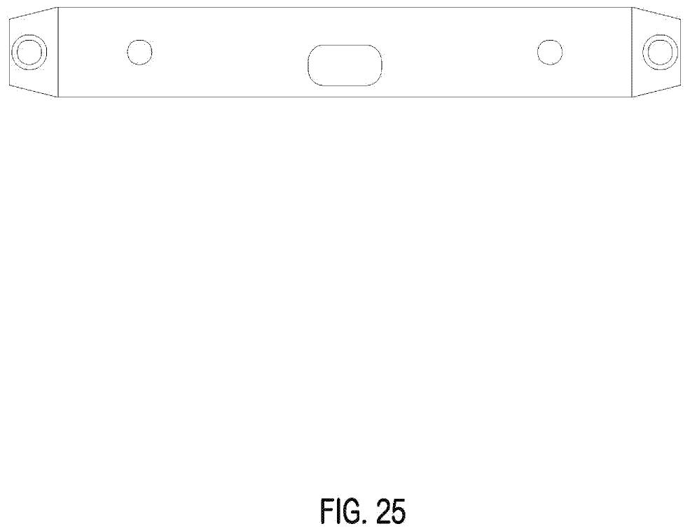

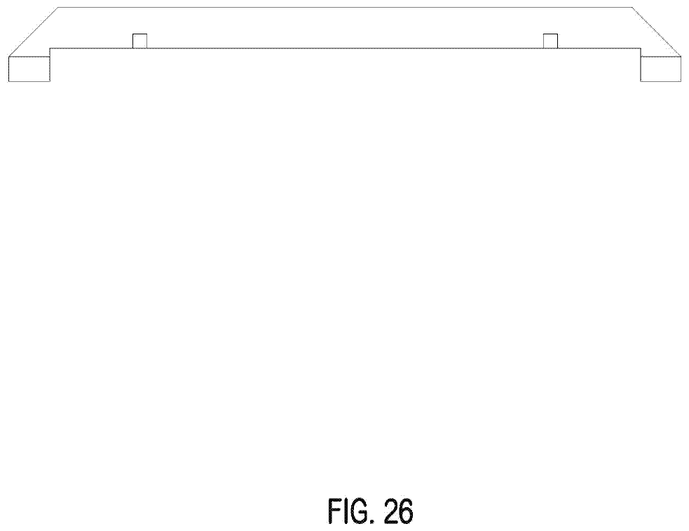

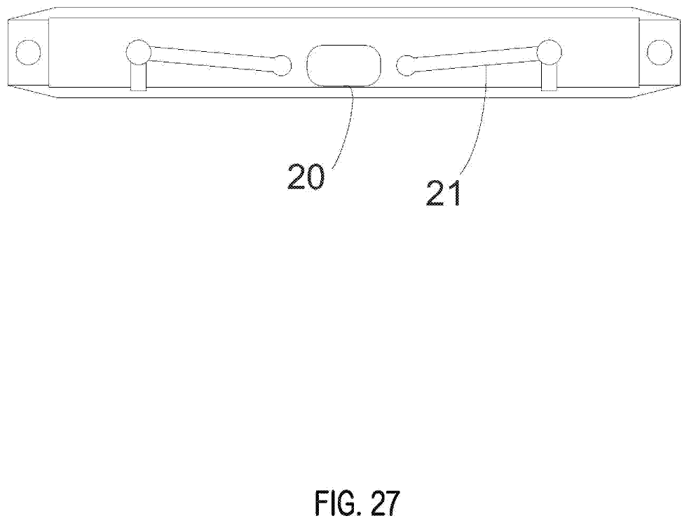

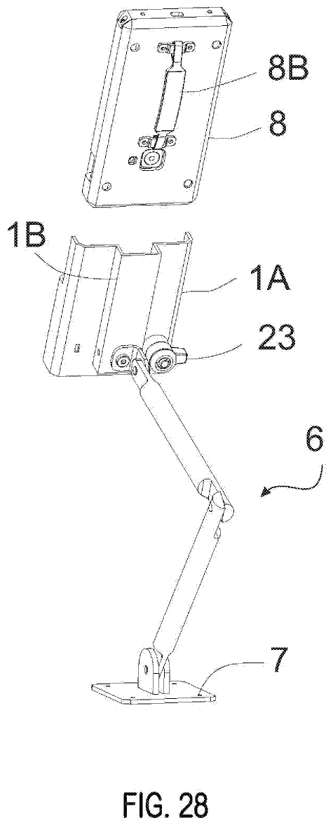

Referring now to any of the accompanying FIGS. 1-29, an AIDC device cradle 1 is illustrated. In one embodiment, the AIDC device cradle 1 comprises a tray 1A configured to receive an AIDC case 8 and AIDC device 9 (or PDA). In one embodiment, the tray 1A is rectangular and sized and shaped to receive a rectangular AIDC device. In alternative embodiments, the tray 1A is configured to receive just the AIDC device without the AIDC case 8. Although, the popular AIDC devices and corresponding AIDC cases are rectangular, it should be understood that the shape may vary in alternative embodiments such that other shaped AIDC devices may be accommodated.

Advantageously, in one embodiment, the tray 1A includes only a base portion configured to secure and cradle the bottom portion of the AIDC case and/or AIDC device such that multiple sized AIDC cases and AIDC devices may be received by the tray 1A. The side walls 4 and 5 help secure the AIDC device and/or AIDC case from lateral movement within the tray 1A. In one embodiment, the side walls or other walls of the tray 1A include openings/slots 14 configured to receive a plurality of fastener options or locks, wherein the fasteners enable the AIDC device cradle to lock in the AIDC device and/or AIDC case within the tray 1A. In one embodiment, the fasteners are screws, but other securement methods or elements may be used as well-known in the art, including but not limited to cam levers, laptop security locks 23, or other quick-locking devices. In some embodiments, slots 15 are also provided on the AIDC case such that the AIDC case and AIDC device is capable of being locked within the present invention. Advantageously, the openings/slots 14 on the tray 1A are configured to line up with slots 15 on the AIDC case making it easy to lock with AIDC case and AIDC device within the tray 1A.

In some embodiments, the AIDC device 9 and AIDC case 8 is symmetric such that the orientation of the device/case is not critical and the AIDC case and AIDC device may be inserted into the tray 1A while facing up or down, such that the barcode scanner 17 on the AIDC device may be positioned up or down when installed in the AIDC device cradle 1. Advantageously, the tray 1A includes a cutout 18 on a bottom portion of the tray 1A enabling the scanner 17 to have a view port 18 such that it is operational within the AIDC device cradle when the AIDC device is in either orientation. A view port 18B is also provided on the AIDC case such that the AIDC case does not block the view port 18 opening provided on the tray 1A.

In one embodiment, the AIDC device cradle 1 further comprises a stand comprised of a movable arm 6 attached to a base plate 7, wherein the stand includes an axle head 11 on the top portion of the movable arm 6. In one embodiment, the tray 1A is rotatably connected to the axle head 11 via pivot pin 10, which enables the tray 1A and attached AIDC device to rotate about the axle head 11 to any desirable angle. In some embodiments, the base plate includes holes 16 enabling fasteners to secure the base plate to a surface. In one embodiment, the movable arm 6 is comprised of a first section 6A and a second section 6B enabling the AIDC device cradle 1 freedom of motion in a variety of directions, particularly the height of the attached tray 1A is easily manipulated for ease of use. More specifically, a first pivot member 6C enables rotation of the first section 6A at least in one axis, a second pivot member 6D enables rotation of the second section at least in one axis, and the second section is attached to the axle head via pivot pin 10 as previously discussed.

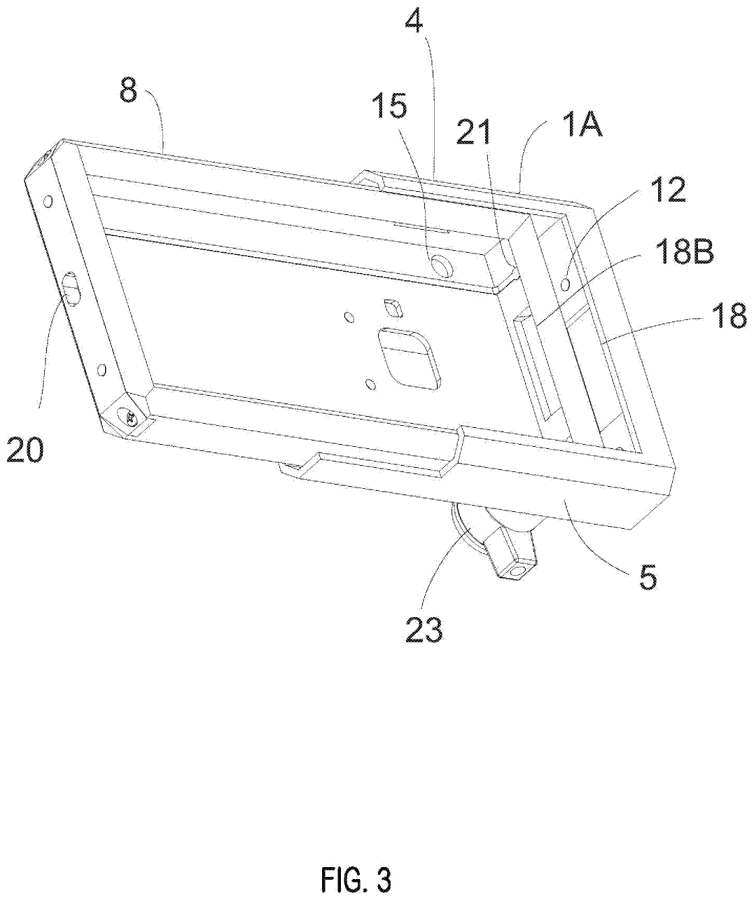

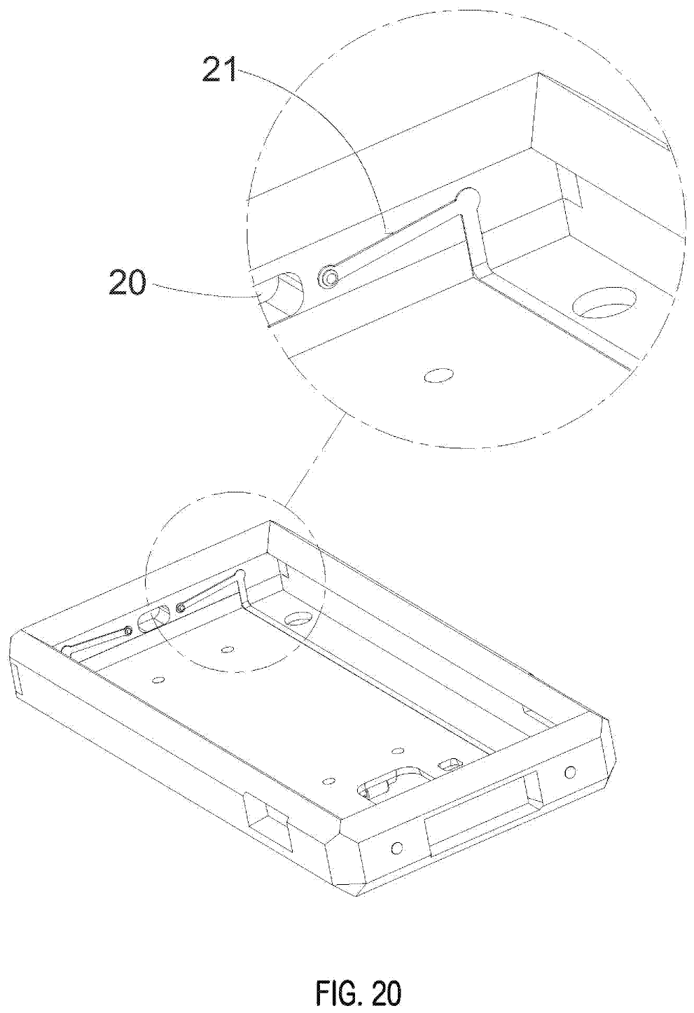

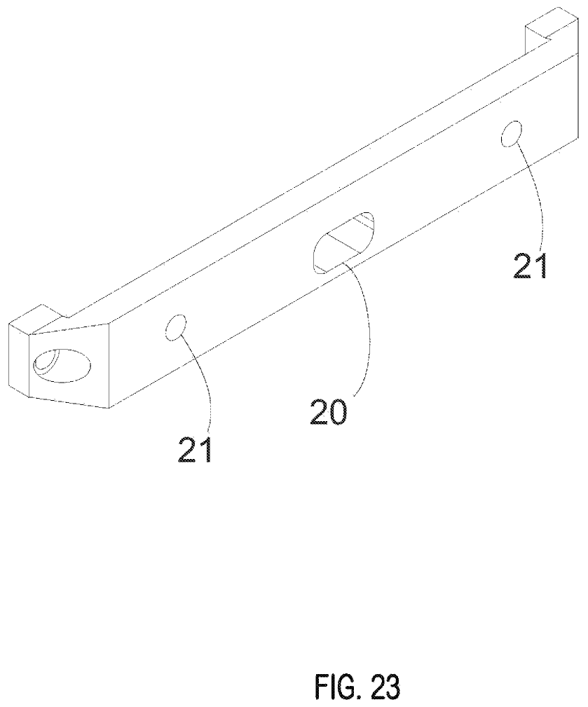

Best seen in FIG. 20, a charger connection 12 is integrated in the inner portion of the tray 1A of the AIDC cradle device 1, wherein the charger connection 12 provides power to the AIDC device via electrical wiring 21 when the AIDC device is situated in AIDC Case and inserted into the tray 1A. Contact pads 21 positioned within the AIDC case 8 are configured to touch the charger connection 12 when the AIDC case 8 and AIDC device are installed within the tray 1A for use. The tray 1A may receive a power cord (not illustrated) as well known in the art. In other embodiments, the AIDC device is configured to change wirelessly via an integrated wireless charging component on the AIDC cradle. In some embodiments, other ports or connections may be provided for charging, data transfer, etc., such as, USB, serial, parallel ports, or similar. Shown in FIG. 23 is the AIDC case end panel with USB cable access hole 20 and charger contact pins 21 which connects with charger pogo pins (12; FIG. 3) in the base AIDC charger cradle.

It should be understood that the materials may vary, however, in one embodiment the AIDC cradle device 1 including the tray 1A, movable arms, stand, and base are constructed from a rigid material, such as metal or plastic. In one embodiment, the AIDC case 8 is made from a rigid yet flexible material, including but not limited to, rubber, silicone, PVC, ABS plastic, or similar.

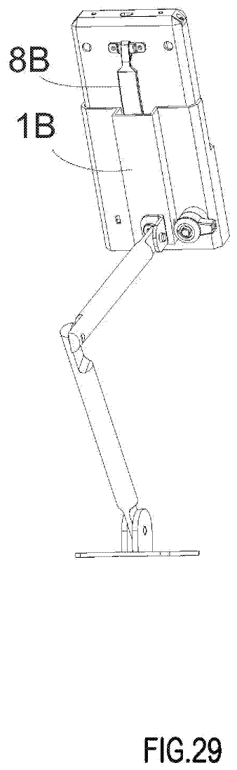

In some embodiments, the AIDC case includes a handle 8B or similar means to hold the AIDC case and installed AIDC device. Best seen in FIG. 29, in some embodiments, the tray 1A includes a rectangular pop out 1B included on the rear portion of the tray 1A to accommodate the handle 8B.

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such, those skilled in the art will appreciate the descriptions and depictions set forth in this disclosure are merely meant to portray examples of preferred modes within the overall scope and intent of the invention and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counterclockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. An AIDC device cradle comprising:
a cradle tray rotatably attached to the axle head via a pivot pin, wherein the cradle tray is configured to receive an AIDC device case, the AIDC device case is configured to hold an AIDC device having a scanner, wherein the cradle tray includes a plurality of openings enabling a user to lock the AIDC device case within the cradle tray; and,
a bottom side of the cradle tray and an end portion of the AIDC device case each having a view port opening enabling the scanner to be operational within the AIDC device cradle when the scanner is in a downward position.

2. The AIDC device cradle of claim 1, wherein the cradle tray and the AIDC case each comprise an integrated charger connection configured to charge the AIDC device when the AIDC device is positioned in the AIDC device cradle.

3. The AIDC device cradle of claim 1, further comprising a stand having a top portion and a bottom portion, the bottom portion attached to a base plate and the top portion attached to an axle head;

4. The AIDC device cradle of claim 3, wherein the stand includes a movable arm having a first portion and a second portion, wherein the first portion is attached to the base plate and the top portion is attached to the axle head.

5. The AIDC device cradle of claim 3, wherein the base plate includes holes configured to receive fasteners such that the base plate may be fixed to a surface.

6. The AIDC device cradle of claim 1, wherein the AIDC device cradle is constructed from a rigid material.

7. The AIDC device cradle of claim 1, wherein the cradle tray is configured to receive the AIDC device case and AIDC device in either vertical orientation such the scanner is in an upward or downward position.

8. The AIDC device cradle of claim 1, wherein the cradle tray includes a first plurality of slots and the AIDC device case includes a second plurality of slots, wherein at least one slot of the first plurality of slots is configured to line up with at least one slot of the second plurality of slots when the AIDC device case is positioned within the cradle tray such that a locking member may lock the AIDC device case to the cradle tray via lined up slots.

9. The AIDC device cradle of claim 8, wherein the locking member is a laptop security lock.
